(19) United States
(12) Patent Application Publication
(10) Pub. No.: US 2017/0153802 A1
(43) Pub. Date: Jun. 1, 2017

(54) CHANGING CONTEXT AND BEHAVIOR OF A UI COMPONENT

(71) Applicant: International Business Machines Corporation, Armonk, NY (US)

(72) Inventors: Mustansir Ali, Hornsby (AU); Bobby Joseph, Ashfield (AU)

(21) Appl. No.: 15/186,700

(22) Filed: Jun. 20, 2016

Related U.S. Application Data
(63) Continuation of application No. 14/953,506, filed on Nov. 30, 2015.

(51) Int. Cl. G06F 3/0484; G06F 17/27

(52) U.S. Cl. CPC G06F 3/04847; G06F 3/04842; G06F 17/276

(57) ABSTRACT

An approach for changing the context and behavior of a user interface component is provided. The approach involves receiving text input or an entry from a user interface component, which can be a text input field, processing the text input or entry based on one or more selected control states provided by one or more control widgets, updating the user interface component and updating an action handler and/or an autocomplete module based on a change to the one or more selected control states.

### BACKGROUND

The present invention relates generally to the field of device applications and more particularly to spatially limited user interfaces.

With the rise of mobile computing technology, many program applications designed specifically for use on a mobile device are being developed. These applications have a great number of uses and functions and can be, for example, calendars, email clients, social media accounts, games, web browsers and more. User interfaces are interactive virtual modules rendered on a display screen that mobile device users can interact with to navigate and direct the functionality of mobile applications. Mobile application developers must, however, take into account the limited amount of screen space available on a mobile device when designing applications and the user interfaces they employ. Further, some application user interfaces, while not specifically intended for mobile devices, may nonetheless be designed to be compact with regard to the total amount of screen space available on the computing device on which they operate.

### SUMMARY

According to one embodiment of the present invention, a method for changing the context and behavior of a user interface component is provided, the method comprising receiving input from a user interface component; processing the input based on one or more selected control states provided by one or more control widgets; updating the user interface component; and responsive to a change to at least one of the one or more selected control states, updating at least one of an action handler and an autocomplete module, wherein the action handler processes the input.

### BRIEF DESCRIPTION OF THE DRAWINGS

FIG. 1A-B is a functional block diagram illustrating a distributed data processing environment and a functional block diagram illustrating components of a UI component modifier, respectively, in accordance with an embodiment of the present invention;

FIG. 2 is a flowchart depicting operational steps of a UI component modifier, in accordance with an embodiment of the present invention;

FIG. 3A-B illustrates an example of use case of a UI component modifier and another example use case of a UI component modifier with a destination control widget, respectively, in accordance with embodiments of the present invention;

FIG. 4A-B depict example use cases with different identifier prefixes, in accordance with an embodiment of the present invention; and

FIG. 5 is a functional block diagram of components of a mobile device, in accordance with an embodiment of the present invention.

### DETAILED DESCRIPTION

Embodiments of the present invention recognize that many user interface (UI) designs for mobile device applications tend to be cluttered and inefficient with regards to the limited amount of screen space that is available to them. Therefore, mobile device applications stand to benefit from user interfaces that are both user friendly (i.e., easy to use) and space efficient. With this in mind, embodiments of the present invention provide a user interface design solution wherein multiple different UI components, having different functions and contexts, can be consolidated, in a mobile application and/or any application with a spatially limited user interface, into a single UI component that can be easily controlled with one or more control widgets to save space on a display screen.

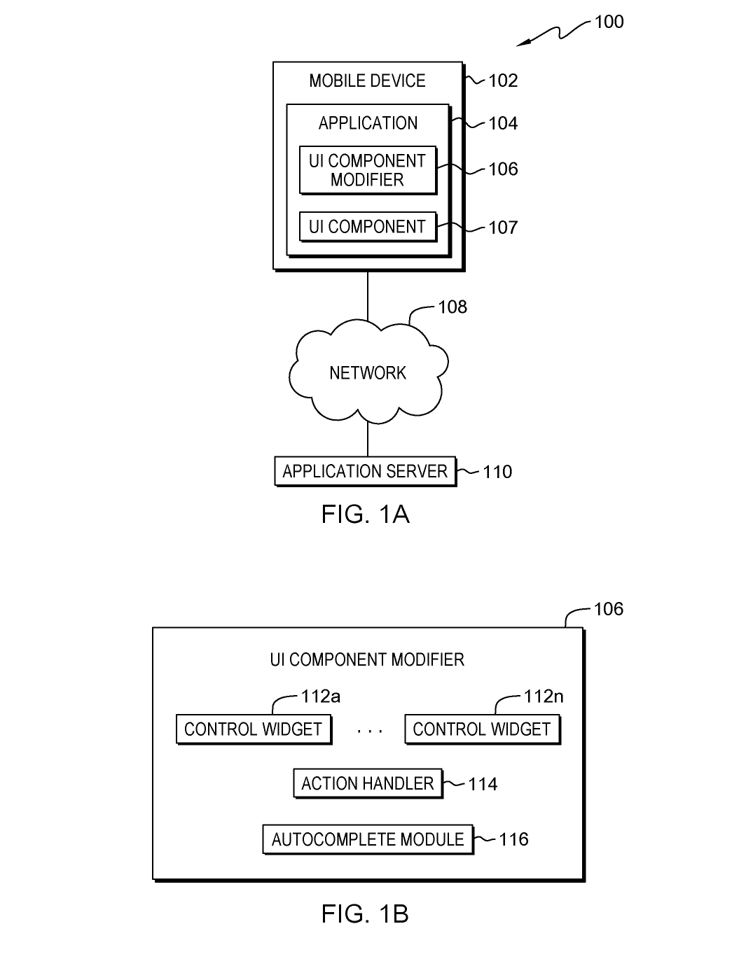

The present invention will now be described in detail with reference to the figures. FIG. 1 is a functional block diagram illustrating a distributed data processing environment, 100, in accordance with one embodiment of the present invention. Distributed data processing environment 100 includes mobile device 102 and application server 110, interconnected over network 108.

Mobile device 102 can be, in general, a laptop computer, tablet computer, netbook computer, personal computer (PC), a desktop computer, a personal digital assistant (PDA), a smart phone, or any programmable electronic device capable of communicating with application server 110 via network 108. It should be noted that although the disclosure provided herein refers primarily to the use of embodiments as they pertain to mobile devices (e.g., smartphones, tablets, etc.), this is not intended to be restrictive and some embodiments can be configured for use with applications on any sort of computer system (e.g., a desktop computer, a laptop computer, etc.) capable of communicating with application server 110.

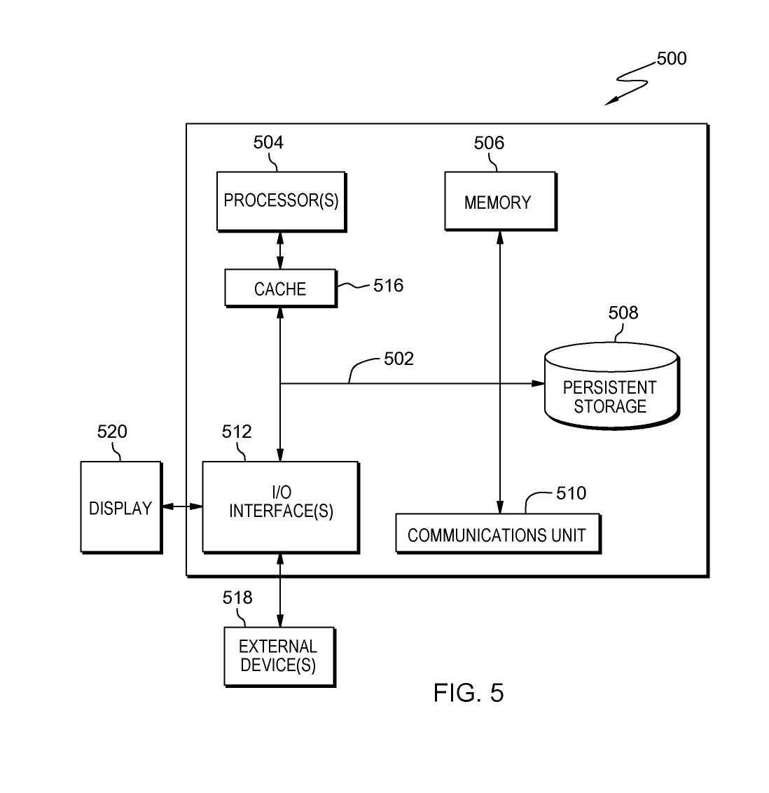

Network 108 can be, for example, a local area network (LAN), a wide area network (WAN) such as the Internet, or a combination of the two, and can include wired, wireless, or fiber optic connections. In general, network 108 can be any combination of connections and protocols that will support communications between mobile device 102 and application server 110. Mobile device 102 can include internal and external hardware components, as depicted and described in further detail with respect to FIG. 5.

Mobile device 102 is installed with application 104 which can be, but is not limited to, a web browser, an email application, a social media application, etc. Application 104 is configured to communicate, via network 108, with application server 110 to send and retrieve data related to the content of application 104. Application 104 comprises UI component modifier 106 and UI component 107. UI component 107 is a virtual module, such as, but not limited to, a text input field, configured for user interaction and can have functions such as, but not limited to, search, post and calculate for entries made in it.

FIG. 1B is a functional block diagram illustrating components of UI component modifier 106, in accordance with an embodiment of the present invention. UI component modifier 106 is a program comprising control widgets 112a-n (which, in general, represent any number of control widgets), action handler 114 and autocomplete module 116. UI component modifier 106 communicates with UI component 107 to change the functionality and context of UI component 107 in application 104. Control widgets 112a-n each provide a plurality of control states that can, for example, set an action (e.g., search, post, calculate, etc.) taken by action handler 114 upon receiving an entry (e.g., sent text input) from a user and/or determine a context for UI component 107. The context of UI component 107 can be associated with a destination where the actions taken by action handler 114 can occur and/or can be associated with a scope of input suggestions (i.e., suggested terms) that are presented by autocomplete module 116. Some examples of destinations where actions taken by action handler 114 can occur can be, but are not limited to, blogs, forums, websites, email accounts and social media accounts. It is to be understood that according to some embodiments, UI component modifier 106 can be a stand-alone program application which can communicate with one or more other applications and/or programs on mobile device 102.

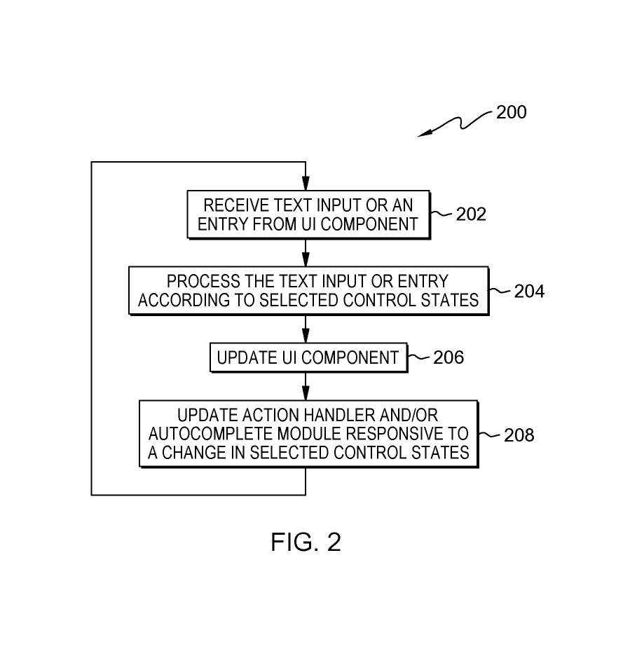

FIG. 2 is a flowchart 200 depicting operational steps of UI component modifier 106, in accordance with an embodiment of the present invention. Action handler 114 receives, at block 202, text input or an entry from UI component 107. The text input or entry received is processed, at block 204, by action handler 114 based on one or more selected control states set by control widgets 112a-n. The processing of action handler 114 can include, but is not limited to, sending the text input received to autocomplete module 116 or taking an action with the entry based on at least one of the selected control states. Autocomplete module 116 can retrieve and present one or more suggested terms, associated with the text input, based on an autocomplete control state which defines the scope of the suggested terms. For example, if the autocomplete control state is set to “users,” suggested terms presented will be filtered (by autocomplete module 116) to only include the names of users of application 104.

Action handler 114 updates, at block 206, UI component 107 based on the processing of block 204. For example, action handler 114 can send data to UI component 107 to automatically fill (i.e., auto-fill) a word in for the text input. Auto-filled words can be based on suggested terms returned to action handler 114 by autocomplete module 116, wherein the suggested terms can be, for example, presented in a list and the suggested term at the top of the list is the word that is auto-filled by default until another suggested term is chosen by the user.

Action handler 114 and/or autocomplete module 116 can be updated, at block 208, responsive to a change of the one or more selected control states. If a user interacts with control widgets 112a-n they can change the selected control states that set, for example, an action to be taken with the entry received at block 202 or the scope of suggested terms presented by autocomplete module 116. Some examples of how a user can interact with control widgets 112a-n can include, but are not limited to, selecting control widgets 112a-n by touch (on a touch screen enabled device), clicking on them (i.e., with a mouse pointer), shaking mobile device 102 to toggle them and using keyboard keys to toggle them. It should further be noted that control widgets 112a-n can be, for example, but are not limited to, virtual dials, similar in appearance to radio knobs, as will be illustrated subsequently.

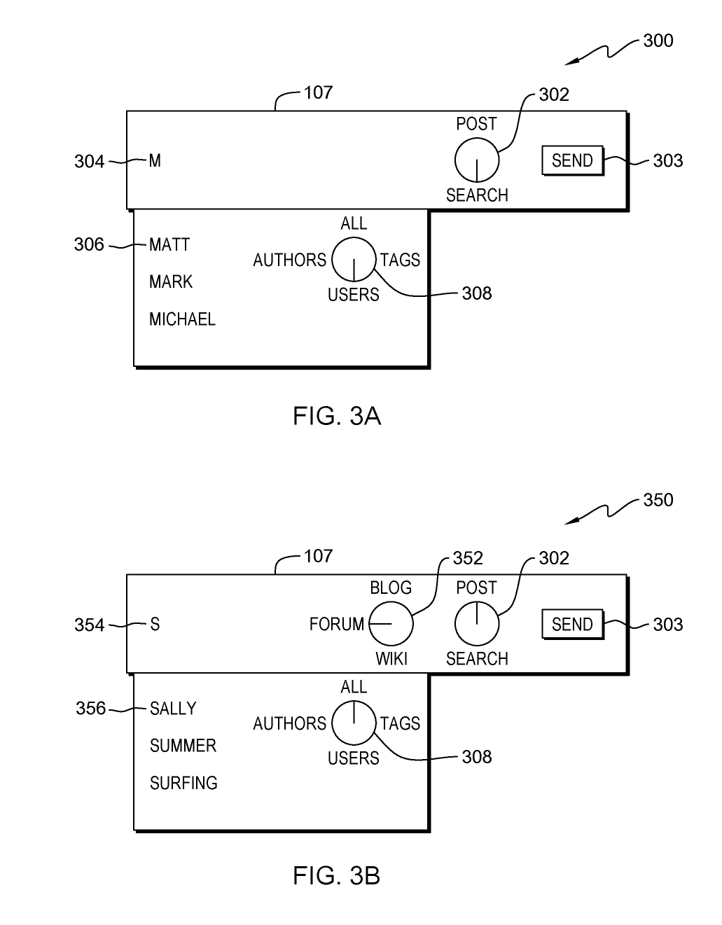

Turning to FIG. 3A, an example use case 300 is illustrated, in accordance with an embodiment of the present invention. In example use case 300, UI component 107 is a text input field containing text input 304, the letter “M”. Action control widget 302 has two possible control states (e.g., “post” and “search”) and is set to “search”. If a user selects send button 303, action handler 114 will take the action set by action control widget 302 with the entry (i.e., the text input sent using send button 303). In the case of the action being set to “search”, selecting send button 303 can result in a new screen, tab or window opening that displays search results associated with the entry. In the case of the action being set to post, selecting send button 303 can result in the entry being posted on the user's account for application 104 (e.g., a status update, a blog post, etc.).

Autocomplete control widget 308 has four possible control states (e.g., “all”, “tags”, “users” and “authors”) that can limit the scope of suggested terms returned by autocomplete module 116 and autocomplete control widget 308 is set to “users”. Accordingly, the presented suggested terms 306 are the names of users of application 104 based on text input 304 and it should be noted that UI component 107 can be subsequently updated by auto-filling the first suggested term (e.g., “Matt”) in the text input field.

FIG. 3B depicts an example use case 350, in accordance with another embodiment of the present invention. UI component 107 in example use case 350 has destination control widget 352 with three possible control states (e.g., “blog”, “forum” and “wiki”) that are target destinations for actions taken by action handler 114. Example use case 350 could be an example implementation of an embodiment wherein application 104 is a web browser. It should be noted that a user can specify (i.e., preselect) destinations (e.g., specific websites, forums, blogs, social media accounts, etc.) associated with possible control states for destination control widget 352. Text input 354 is the letter “S” and autocomplete control widget 308 is set to “all” (i.e., the “all” control state comprises at least all of the other control states for autocomplete control widget 308). Accordingly, suggested terms 356 reflect a broader scope of suggested terms than if autocomplete control widget 308 was set to a more narrow control state, such as “users”, for example.

According to some embodiments, if autocomplete control widget 308 is selected (i.e., toggled to a different control state) while one or more suggested terms are presented, the presented suggested terms can be filtered based on the new control state selected or a new set of suggested terms can be presented by a new search performed by autocomplete module 116.

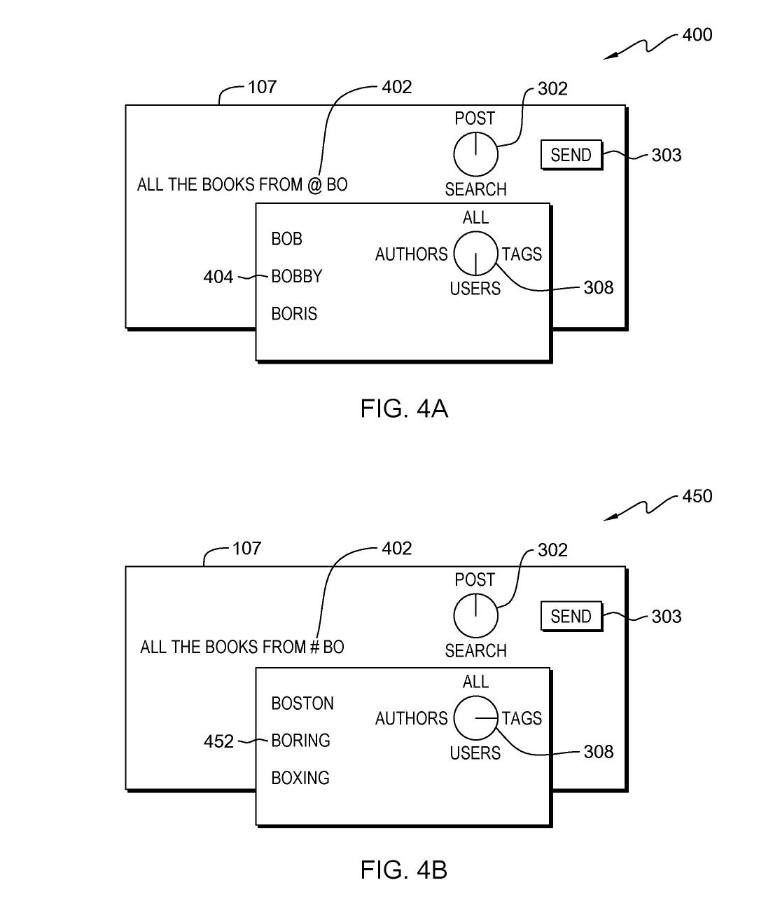

FIG. 4A illustrates an example use case 400 of UI component modifier 106 with identifier prefix 402, in accordance with an embodiment of the present invention. A user has typed identifier prefix 402, i.e., “@”, into UI component 107 and has additionally input “bo” after identifier prefix 402. According to some embodiments, typing a special symbol, such as identifier prefix 402, can automatically change the control state of autocomplete control widget 308 to a control state associated with identifier prefix 402. For example, the control state of autocomplete control widget 308 in example use case 400 can be automatically set to “users” when the symbol “@” is recognized and suggested terms 404 presented will be filtered accordingly.

FIG. 4B depicts an example use case 450 wherein identifier prefix 402 has been changed to the symbol “#”, in accordance with an embodiment of the present invention. If a user edits identifier prefix 402, the control state of autocomplete control widget 308 can be automatically adjusted to reflect the change. For example, changing identifier prefix 402 from “@” to “#” will change the control state of autocomplete control widget 308 from “users” to “tags” and suggested terms 452 reflect this change, as a new search for suggested terms has been performed. It should be further noted that according to some embodiments, if autocomplete control widget 308 is toggled to a different control state, this action can automatically update identifier prefix 402. For example, if identifier prefix 402 is the character “@” and then a user subsequently toggles autocomplete control widget 308 to “tags”, identifier prefix can be automatically changed from “@” to “#” and suggested terms presented can be accordingly refreshed.

FIG. 5 depicts a block diagram 500 of components of mobile device 102 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Mobile device 102 includes communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Application 104 and UI component modifier 106 can be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Application 104 and UI component modifier 106 can be downloaded to persistent storage 508 through communications unit 510.

I/O interface(s) 512 allows for input and output of data with other devices that can be connected to mobile device 102. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., application 104 and UI component modifier 106, can be stored on such portable computer readable storage media and can be loaded onto persistent storage 508 via I/O interface(s) 512. I/O interface(s) 512 also connect to a display 520.

Display 520 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for changing a context and behavior of a user interface component, the method comprising:
receiving input from a user interface component;
processing the input based on one or more selected control states provided by one or more control widgets;
updating the user interface component; and
responsive to a change to at least one of the one or more selected control states, updating at least one of an action handler and an autocomplete module, wherein the action handler processes the input.

2. The method of claim 1, wherein the one or more control widgets comprise at least one of an action control widget, an autocomplete control widget and a destination control widget.

3. The method of claim 1, wherein the action handler takes an action responsive to receiving an entry from the user interface component.

4. The method of claim 3, wherein the action comprises one of searching, posting and calculating.

5. The method of claim 2, wherein the autocomplete module comprises at least one of filtering and presenting suggested terms based on an autocomplete control state associated with the autocomplete control widget.

6. The method of claim 1, wherein the user interface component is a text input field.

7. The method of claim 1, wherein the user interface component is disposed in at least one of a mobile application and an application with a spatially limited user interface.
